(19) United States
(12) Patent Application Publication
(10) Pub. No.: US 2025/0385466 A1
(43) Pub. Date: Dec. 18, 2025

(54) ELECTRICAL CONNECTOR ASSEMBLIES AND CONNECTOR ASSEMBLY

(71) Applicant: Lear Corporation, Southfield, MI (US)

(72) Inventors: Martin Komorniczak, Remscheid (DE); Uemit Celiker, Schwelm (DE); Xavier Farre Vives, Valls (ES); Jordi Angel Serrano, Cologne (DE)

(73) Assignee: Lear Corporation, Southfield, MI (US)

(21) Appl. No.: 19/230,559

(22) Filed: Jun. 6, 2025

(30) Foreign Application Priority Data
Jun. 14, 2024 (DE) 10 2024 116 841.2

(51) Int. Cl. H01R 13/627; H01R 13/02; H01R 13/502; H01R 13/533

(52) U.S. Cl. CPC H01R 13/6273; H01R 13/025; H01R 13/502; H01R 13/533

(57) ABSTRACT

An electrical connector assembly comprising a first component comprising a first side wall, comprising a first cavity and a first retaining element positioned adjacent to the first cavity, and a second side wall opposite to the first side wall, the second side wall comprising a second cavity and a second retaining element positioned adjacent to the second cavity; and a second component, operatively coupled to the first component, and configured to receive the first component, wherein the second component comprises: a first portion, wherein the first portion comprises: a third side wall, and a fourth side wall opposite to the third side wall, wherein the third side wall comprises a third retaining element and the fourth side wall comprises a fourth retaining element, and a second portion.

### CROSS-REFERENCE TO RELATED APPLICATIONS

This application claims the benefit of and priority to German Patent Application 10 2024 116 841.2, filed Jun. 14, 2024, the disclosure of which is hereby incorporated by reference in its entirety as though fully set forth herein.

### TECHNICAL FIELD

The present disclosure relates to an electrical connector assembly. More specifically, the present disclosure relates to locking retainers of the electrical connector assembly.

### BRIEF DESCRIPTION OF THE DRAWINGS

FIG. 1 illustrates a connector assembly, in accordance with an exemplary embodiment of the present disclosure;

FIG. 2 illustrates a schematic, perspective view of an electrical connector assembly, in accordance with an exemplary embodiment of the present disclosure;

FIGS. 3A and 3B respectively illustrate schematic cross-sectional views of a first component and a second component of an electrical connector assembly, in accordance with an exemplary embodiment of the present disclosure;

FIG. 3C illustrates a cross-sectional view of a plurality of electrical terminals of an electrical connector assembly, in accordance with an exemplary embodiment of the present disclosure;

FIG. 3D illustrates a cross-sectional top view of an electrical connector assembly, in accordance with an exemplary embodiment of the present disclosure;

FIG. 3E illustrates a cross-sectional view of an engagement operation of the first component with the second component in a first orientation, in accordance with an exemplary embodiment of the present disclosure;

FIG. 3F illustrates a cross-sectional view of an engagement operation of the electrical connector assembly in a second orientation, in accordance with an exemplary embodiment of the present disclosure;

FIG. 3G illustrates a cross-sectional view of the electrical connector assembly in a third orientation, in accordance with an exemplary embodiment of the present disclosure;

FIG. 3H illustrates a cross-sectional view of the electrical connector assembly in a fourth orientation, in accordance with another exemplary embodiment of the present disclosure; and

FIG. 4 illustrates a cross sectional view of a third component of an electrical connector assembly, in accordance with an exemplary embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

In modern automotive systems, electrical connectors play a pivotal role in establishing secure and reliable connections between various parts of the automotive systems. Conventionally, electrical connector assemblies comprise multiple parts such as housings, brackets, terminals, and retaining elements, designed to facilitate the transmission of electrical signals and power throughout a vehicle and ensure retention of interconnected components of the automotive systems. Typically, the electrical connector assemblies are used for selectively providing mechanical and electrical connections between various vehicle components such as sensors, actuators, and control modules. In the automotive industry, the electrical connector assembly facilitates the seamless operation of critical functions such as engine management, safety systems, and infotainment. Notably, the retaining elements play a crucial role in ensuring the stability and integrity of the electrical connector assemblies in various applications. For instance, in automotive systems, the retaining elements are used for maintaining secure connections between components such as sensors, actuators, and control modules. Moreover, crucial functions such as engine management, safety systems, and infotainment could be compromised without reliable retention mechanisms, leading to potential vehicle malfunctions or safety hazards. In this regard, the conventional electrical connectors encounter challenges such as misalignment of their parts with respect to each other during their assembly. For example, the retaining elements get damaged when the housing and the bracket are engaged together in a misaligned or oblique (namely, a decentered) position. Moreover, said misalignment results in inadequate retention forces, and complex assembly procedures, thus leading to inefficiencies and potential reliability issues within the retention mechanism of the automotive systems. Furthermore, the conventional electrical connectors are complex in design and at times fail to address dynamic requirements of modern vehicle architectures.

Typically, in the conventional electrical assemblies upon assembling, the housing of the electrical connector applies insertion forces on the bracket portion of the electrical connector. The insertion force for the electrical assembly is determined based on the position on which the housing is getting assembled into the bracket. In such a case, in the decentered position the electrical connector assemblies encounter unequal insertion forces in the retaining elements, thus damaging or breaking the retaining element before being assembled. Additionally, in the decentered position the retention forces on the retaining element are zero due to an absence of overlapping between the retaining elements. The zero retention forces fail to hold the housing in appropriate position, thereby causing the housing to be pulled out easily.

There exist some electrical connectors that include a clearance section between the housing and the bracket to absorb a chain of tolerances. Moreover, the clearance section ensures that the components are joined together without requiring for a human intervention such as a visual alignment or inspection during assembly thereof. However, the clearance section results in the misalignment of the retaining elements from a center position of the electrical connector. Furthermore, the clearance section causes the unlocking of the retaining elements.

Consequently, an improved electrical connector assembly is required that offers enhanced stability, reliability, and ease of assembly to meet the dynamic requirements of the modern vehicle architectures.

The present disclosure provides the electrical connector assembly that comprises a dual-retaining mechanism. In this regard, the electrical connector assembly comprises one or more electrical components such as, a first component and a second component. In accordance with an example embodiment, the second component is operatively coupled with the first component. In accordance with the said example embodiment, the first component can comprise a housing defined by a first side wall and a second side wall. Further, the first component comprises a first retaining element and a second retaining element on the first side wall and the second side wall thereof, respectively. Similarly, the second component comprises a third retaining element and a fourth retaining element defined on a third side wall and a fourth side wall, respectively of the second component. The technical effect of employing the first retaining element and the second retaining element is to guide the first component and allow the insertion of the first component into the second component at the centered position, during an engagement operation of the first component and the second component (for example, in an operation of electrical connection). Moreover, the first retaining element and the second retaining element are defined such that these elements apply symmetrical insertion forces on the third retaining element and the fourth retaining element of the second component, respectively. In accordance with various example embodiments described hereinafter, the first retaining element and the second retaining elements are designed so as to provide a secondary retaining function (in addition to a primary retention of the first component and the second component) when one of the first retaining element or the second retaining element, dislocates from the centered position while attempting an engagement of the components.

Further, the first retaining element and the second retaining elements are designed so as to enable control over the insertion forces for the electrical connector assembly. Moreover, the first retaining element and the second retaining elements of the electrical connector assembly are defined as so as to prevent the electrical connector assembly from a damage or a wear and tear.

In another example embodiment, the electrical connector assembly also comprises a third component in addition to the first component and the second component. In this regard, the third component can be operatively coupled to the first component and the second component, via one or more engagement means. Further, the third component can be configured to provide a secondary locking mechanism between the first component and the second component.

By way of implementation of various example embodiments described herein, the electrical connector assembly is designed so as to offer a distinct advantage by integrating multiple components that work in conjunction with each other to enhance the functionality and reliability of the electrical connector assembly. For instance, the first component of the electrical connector assembly can define various strategically positioned cavities and retaining elements that enables precise alignment and insertion of the members of the first component with the members of the second component. Further, the second component's design, featuring corresponding retaining elements and cavities, ensures secure reception of the first component. Moreover, in accordance with various example embodiments described herein, the first component and the second component enable establishment of a robust connection mechanism between the electrical components. In this regard, one or more members defined on the first component and the second component enables guiding of the first component towards the second component in an axial direction to achieve a centered position (i.e., alignment) required to ensure appropriate engagement. To this extent, the said alignment and the design of the electrical connector assembly not only simplifies the component assembling process but also minimizes any risk of misalignment or disconnection during operation.

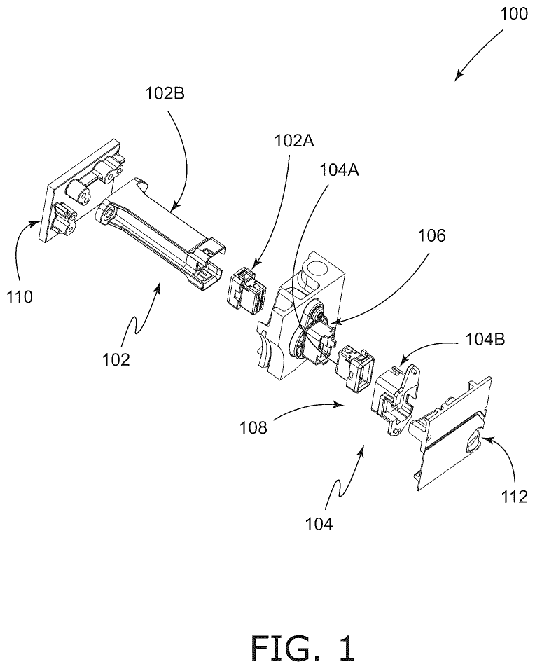

Referring to FIG. 1, illustrated is a connector assembly 100, in accordance with an exemplary embodiment of the present disclosure. As shown, the connector assembly 100 could be used in various automotive systems or vehicles, where the connector assembly 100 serves as a component facilitating connection between different external components. For instance, the connector assembly 100 can be effectively utilized in automobiles to establish connections between various mechanical components within an engine, transmission, chassis, and other critical sections of the vehicle. In an embodiment, the vehicle could be an electric vehicle, a hybrid vehicle, a truck, a bus, and other types of vehicles where electrical connections between various components are essential for operation.

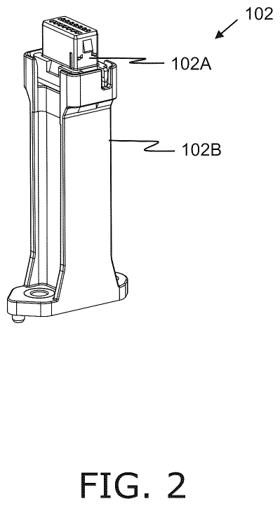

The connector assembly 100 comprises the one or more electrical connector assembly 102 and the feed-through connector assembly 106. Throughout the present disclosure, the term “electrical connector assembly” 102 as used herein refers to an electromechanical device that is used to create an electrical connection between various parts of an electrical circuit, or between different electrical circuits, thereby joining them into a larger electrical circuitry. It will be appreciated that the one or more electrical connector assembly 102 is used for facilitating secure and reliable electrical connections within the vehicle. Each of the one or more electrical connector assembly 102 comprises a first component 102A and a second component 102B. The second component 102B works in conjunction with the first component 102A to establish a secure connection and maintain alignment between the first component 102A and the second component 102B, via one or more retaining elements defined on the first component 102A and the second component 102B. Further details of the retaining elements of the first component 102A and the second component 102B are described in reference to FIGS. 2-4. Notably, the other electrical connector assembly 104, can be designed and configured to function similarly to the electrical connector assembly 102.

Throughout the present disclosure, the term “feed-through connector assembly” 106 as used herein refers to a conductor that is used to carry a signal through an enclosure or printed circuit board. The feed-through connector assembly 106 may serve as a bridge between the one or more electrical connector assemblies 102 and the one or more external components 110, 112 of the vehicles. The one or more external components 110, 112 can include, but are not limited to printed circuit boards, electrical devices, sensors, actuators, lights, motors, and other critical components within the vehicle's infrastructure. The feed-through connector assembly 106 is operatively coupled to the one or more electrical connector assemblies 102 via at least one attachment means 108. Said operative coupling allows for seamless integration and transmission of electrical signals between the one or more electrical connector assemblies 102 and the one or more external components 110, 112. Herein, the term “attachment means” 108 refers to any mechanism or device used to connect, fasten, or secure components together. Examples of the attachment means 108 may include but are not limited to fasteners, clamps, rivets, latches, hooks, and so forth. Additionally, the one or more electrical connector assemblies 102 and the feed-through connector assembly 106 work in conjunction with each other to enable the efficient transmission of the power throughout the vehicle. Furthermore, the connector assembly 100 ensures optimal performance, reliability, and safety, thereby enhancing the overall functionality and driving experience of the vehicle.

Referring to FIG. 2, illustrated is a schematic, perspective view of an electrical connector assembly 102, in accordance with an exemplary embodiment of the present disclosure. As shown, the electrical connector assembly 102 (as depicted in FIG. 1) comprises the first component 102A mounted over the second component 102B. As shown, the second component 102B can serve as a receptacle for the first component 102A in order to facilitate the insertion of the first component 102A and secure attachment between the first component 102A and the second component 102B. In an embodiment, each of the first component 102A and the second component 102B may have a pre-determined shape so as to complement the shape of each other and facilitate seamless engagement of the components. In other words, shape of the first component 102A can be defined such that it complements the shape of the second component 102B (for example, as male and female parts of a connector). In another embodiment, each of the first component 102A and the second component 102B can be defined of based on any pre-determined size as per requirement. In an example embodiment, dimensions of the first component 102A can be smaller than the dimensions of the second component 102B such that first component 102A could be inserted partially and accurately into the second component 102B. Alternatively, in another example embodiment, the first component 102A may be inserted completely into the second component 102B.

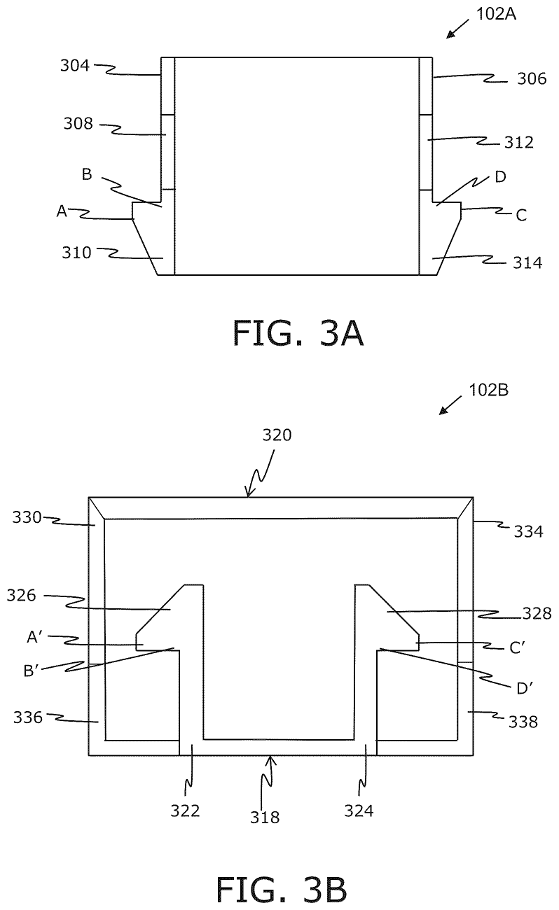

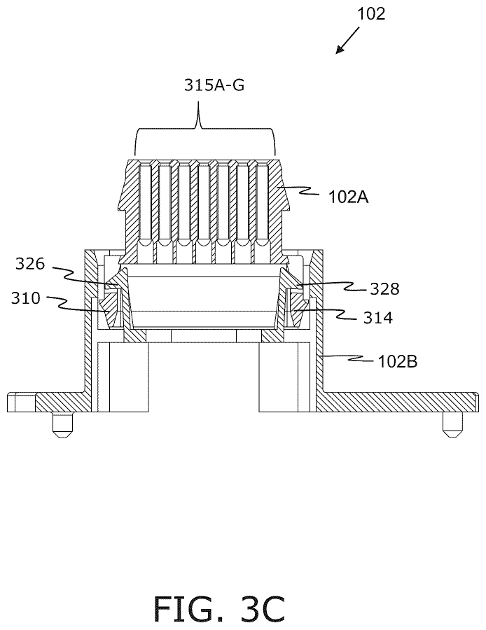

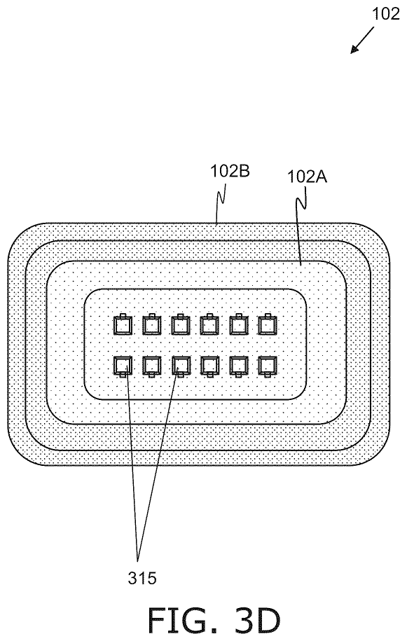

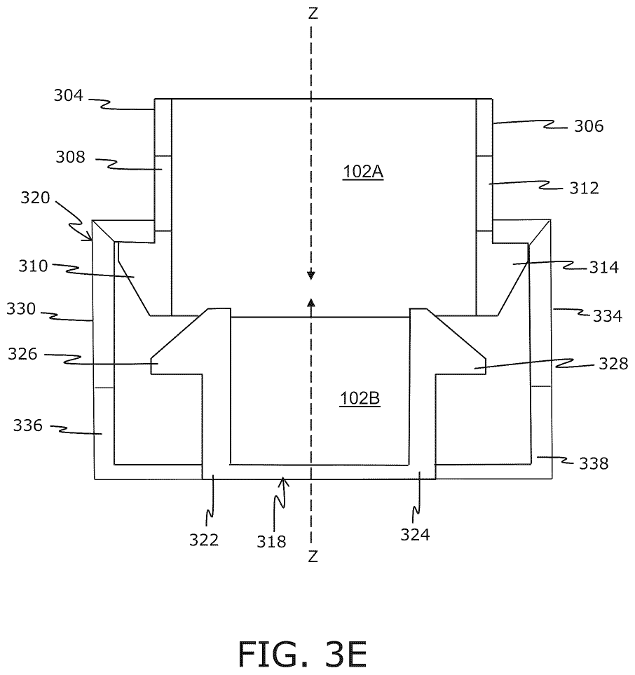

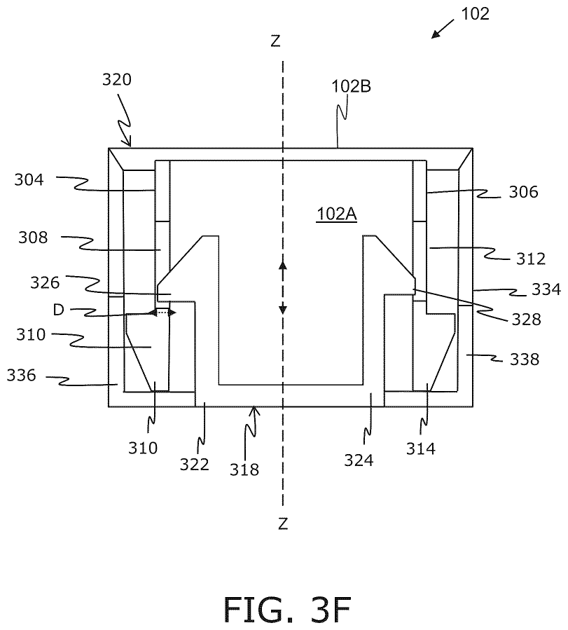

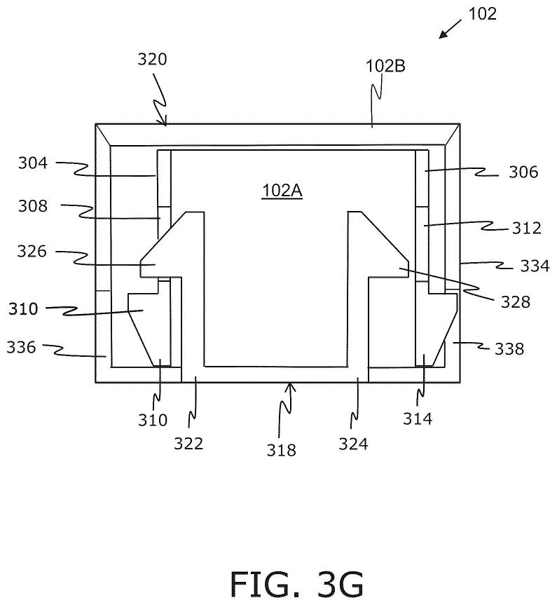

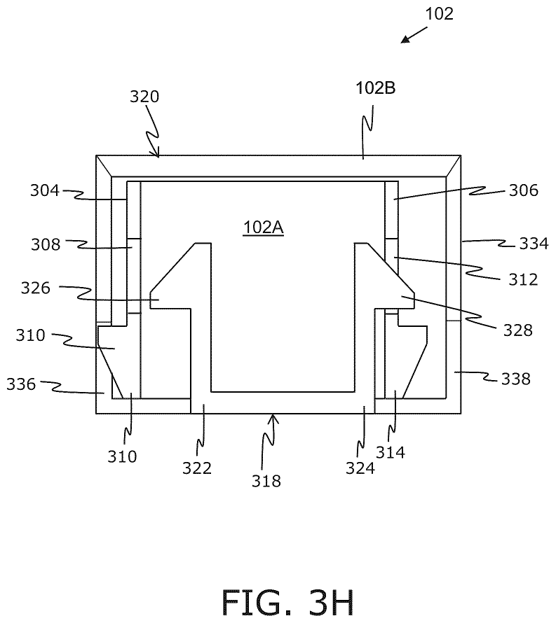

FIGS. 3A and 3B illustrates a schematic cross-sectional view of a first component 102A and a second component 102B of an electrical connector assembly 102 (for example, as described in reference to FIGS. 1 and 2), in accordance with an exemplary embodiment of the present disclosure. With reference to FIG. 3A, there is shown first component 102A. Throughout the present disclosure, the term “first component” 102A as used herein refers to a primary housing connector of the electrical connector assembly 102. As shown, the first component 102A comprises a first side wall 304 and a second side wall 306. The first side wall 304 is positioned opposite the second side wall 306. The first side wall 304 and the second side wall 306 collectively define the outer perimeter (e.g., but not limited to, a housing) of the first component 102A. Within each side wall, various components are incorporated to facilitate the electrical connector assembly's functionality. In an embodiment, the first side wall 304 and the second side wall 306 may function as a housing. Throughout the present disclosure, the terms “first retaining element” 310 and “second retaining element” 314 as used herein refer to mechanical retainers that are designed to securely hold two or more parts together within an assembly. The first retaining element 310 and the second retaining element 314 include structures or mechanisms that engage with corresponding features on the parts being joined, thus creating a secure and stable connection. In the electrical connector assembly, the first retaining element 310 and the second retaining element 314 ensure that the first component 102A and the second component 102B remain firmly attached during assembly. The first retaining element 310 and the second retaining element 314 may be thin wall protrusions that extend perpendicularly from a wall or a plane. In an example, the first retaining element 310 and the second retaining element 314 are ribs or hooks-like structures. The first side wall 304 comprises a first cavity 308 and the first retaining element 310 is positioned adjacent to the first cavity 308, while the second side wall 306 comprises a second cavity 312 and the second retaining element 314 is positioned adjacent to the second cavity 312. Throughout the present disclosure, the term “cavity” refers to a hollow space or recessed area within the walls of the electrical connector assembly 102. The first cavity 308 and the second cavity 312, located within the first side wall 304 and the second side wall 306 respectively, serve as receptacles or openings intended to receive and interact with corresponding features of the second component 102B. The first cavity 308 and the second cavity 312 facilitate the alignment and connection of the first component 102A with the second component 102B, thus ensuring proper assembly and functionality of the electrical connector assembly 102. Moreover, the first component 102A serves as the structural framework and enclosure for the electrical connector assembly 102. The first component 102A provides protection and support for the internal components, ensuring their proper function and longevity.

With reference to FIG. 3B, there is shown the second component 102B. The second component 102B serves as a receptacle for the first component 102A and facilitates the secure connection and alignment between the first component 102A and the second component 102B of the electrical connector assembly 102. The second component 102B comprises the first portion 318 and the second portion 320. The first portion 318 comprises two opposing side walls such as a third side wall 322 and a fourth side wall 324. The third side wall 322 and the fourth side wall 324 collectively define the outer perimeter of the first portion 318. The third side wall 322 comprises the third retaining element 326 and the fourth side wall 324 comprises the fourth retaining element 328. The second portion 320 comprises two additional opposing side walls such as a fifth side wall 330 and a sixth side wall 334. The fifth side wall 330 and the sixth side wall 334 collectively define the outer perimeter of the second portion 320. The fifth side wall 330 comprises a third cavity 336 and the sixth side wall 334 comprises a fourth cavity 338. Herein, the first cavity 308 in the first side wall 304, the second cavity 312 in the second side wall 306, the third cavity 336 in the fifth side wall 330 and the fourth cavity 338 in the sixth side wall 334 refers to a hollow space or a recessed area.

In an embodiment, each of the first retaining element 310 and the third retaining element 326 comprises a proximal end A, A′ and a distal end B, B′. In an embodiment, the proximal end A′ of the third retaining element 326 is configured to lockingly engage with the distal end B of the first retaining element 310. In this regard, the proximal end A′ of the third retaining element 326 is designed to have a complementary shape or feature that allows the third retaining element 326 to securely interlock with the distal end B of the first retaining element 310. The technical effect of said configuration is to reinforce the structural integrity of the third retaining element 326 and the first retaining element 310 within the electrical connector assembly 102. In an example, the electrical connector assembly 102 becomes more resistant to accidental disassembly or loosening during operation by forming a locked connection between the first retaining element 310 and the third retaining element 326. Furthermore, said configuration simplifies assembly and maintenance processes of the electrical connector assembly. Additionally, said configuration provides a secure and stable connection that does not require frequent adjustment or tightening.

In an embodiment, each of the second retaining element 314 and the fourth retaining element 328 comprises a proximal end C, C′ and a distal end D, D′. In an embodiment, the proximal end C′ of the fourth retaining element 328 is configured to lockingly engage with the distal end D of the second retaining element 314. In an embodiment, the proximal end C′ of the fourth retaining element 328 is designed to lockingly engage with the distal end D of the second retaining element 314. It will be appreciated that said feature aims to enhance the stability and security of the connection between the second retaining element 314 and the fourth retaining element 328. Moreover, the proximal end C′ of the fourth retaining element 328 is engineered to have a complementary shape or feature that enables the fourth retaining element 328 to securely interlock with the distal end D of the second retaining element 314.

In an embodiment, the first retaining element 310 or the second retaining element 314 are configured to exert a pre-defined retention force between the first component 102A and the second component 102B. Herein, the term “pre-defined retention force” refers to a given force exerted by the first retaining element 310 or the second retaining element 314 to securely hold the first component 102A to the second component 102B in the electrical connector assembly 102. In an embodiment, the pre-defined retention force is defined based on a size of the first retaining element 310 or the second retaining element 314. For instance, the first retaining element 310 or the second retaining element 314 of a larger size exerts a larger pre-defined retention force between the first component 102A and the second component 102B. The larger size may increase the contact surface area of the first retaining element 310 in contact with the second component 102B. Similarly, the larger size may increase the contact surface area of the second retaining element 314 in contact with the first component 102A. In another embodiment, the pre-defined retention force is defined based on a tolerance of the first retaining element 310 or the second retaining element 314. Herein, tolerance refers to the allowable variation in dimensions during manufacturing of the first component 102A and the second component 102B. In an example, smaller tolerances mean less variation in size between the first component 102A and the second component 102B. For instance, if the tolerance is tight (minimal allowable variation), the first retaining element 310 or the second retaining element 314 may fit precisely, resulting in a reliable and consistent retention force. In an embodiment, the pre-defined retention force is based on a degree of overlapping (depicted as a gap D in FIG. 3F) between the first retaining element 310 of the first component 102A and the third retaining element 326 of the second component 102B. In an embodiment, the pre-defined retention force is calculated based on factors such as the materials used, the geometry and dimensions of the first retaining element 310 and the second retaining element 314 and the first component 102A and the second component 102B, and the application of the electrical connector assembly 102. The technical effect of using the first retaining element 310 and the second retaining element 314 for exerting the pre-defined retention force is to prevent unintended disconnection or movement of the components, even under conditions of vibration, shock, or thermal expansion. Additionally, the first retaining element 310 and the second retaining element 314 enhance the reliability and durability of the electrical connector assembly 102, thus minimizing the risk of electrical interruptions or damage during the operation.

By way of implementation of various example embodiments described herein, the first retaining element 310 or the second retaining element 314 are configured and designed so as to exert the pre-defined retention force. For instance, in some example embodiments, the pre-defined retention force exerted between the components for retention, can be within in a range from about 110 Newtons to about 130 Newtons. More specifically, in another example embodiment, the pre-defined retention force can be within a range from about 112 Newtons to about 128 Newtons. More specifically, in another example embodiment, the pre-defined retention force can be within a range from about, 115 Newtons to about 125 Newtons. In another example embodiment, the first retaining element 310 or the second retaining element 314 are designed and configured so as to exert the pre-defined retention force, for example, about 120 N. It will be appreciated that the first retaining element 310 or the second retaining element 314 ensures optimal performance of the electrical connector assembly 102 by exerting the pre-defined retention force within the aforementioned range. In an embodiment, the aforementioned range is selected based on factors such as the mechanical strength of the fabrication materials used, the anticipated loads and stresses experienced during operation, and industry standards or regulations.

According to various example embodiments described herein, the first component 102A, the second component 102B, and/or the like can be fabricated based on at least one of: a plastic, a glass fiber, a combination thereof. Herein, the term plastic refers to a lightweight and cost-effective material that provides electrical insulation properties, thus making the plastic suitable for use in electrical applications. In an embodiment, the first component 102A and the second component 102B can be fabricated based on glass fiber that provides added strength, rigidity, and heat resistance. In an embodiment, the first component 102A and the second component 102B can be fabricated based on a combination of both the plastic and the glass fiber to provide flexibility in material selection based on specific application requirements of the electrical connector assembly 102.

In an embodiment, the first component 102A and the second component 102B are fabricated using a fabrication process that involves molding or forming the first component 102A and the second component 102B using the aforementioned materials. In an example, the fabrication process can include injection molding, compression molding, resin transfer molding, and so forth. In an embodiment, when the combination of the plastic and the glass fiber is used for fabricating the first component 102A and the second component 102B, a fabrication process such as insert molding may be employed. Advantageously, the glass fiber reinforcement enhances mechanical strength and thermal stability, ensuring the electrical connector assembly 102 to withstand demanding operating conditions without compromising performance. Additionally, the flexibility to choose between the aforementioned materials allow for customization based on factors such as cost, environmental considerations, and specific application requirements.

Referring to FIG. 3C illustrated is a cross-sectional view of a plurality of electrical terminals 315A-G of an electrical connector assembly 102, in accordance with an exemplary embodiment of the present disclosure. Herein, the term “electrical terminals” refers to metal components designed to establish electrical connections between the electrical wires and the external components in the vehicle. Moreover, the plurality of electrical terminals 315A-G serve as intermediary connectors between the electrical wires and the external components, thus ensuring efficient transmission of power within the vehicle. The first component 102A of the electrical connector assembly 102 comprises the plurality of electrical terminals 315A-G. Each of the plurality of electrical terminals 315A-G is terminated to the ends of individual electrical wires, forming a structured network that facilitates the electrical connectivity. This configuration allows for organized and reliable transmission of the electrical signals between the plurality of electrical wires 315A-G and at least one external component.

Referring to FIG. 3D illustrated is a cross-sectional top view of the electrical connector assembly 102, in accordance with an exemplary embodiment of the present disclosure. As shown, the electrical connector assembly 102 comprises a rectangular-shaped configuration with curved edges. The outer layer of the electrical connector assembly 102 corresponds to the second component 102B, while the inner layer represents the first component 102A. In an embodiment, said arrangement enables the first component 102A to snugly fit or be partially inserted inside the second component 102B. It will be appreciated that the snug fit ensures optimal retention forces, thereby enhancing the stability and reliability of the electrical connection between the various components in the vehicle. There is also shown a plurality of terminals 315 within the first component 102A that facilitates the transmission of the electrical signals between different components in the vehicle. Alternatively, the shape of the electrical connector assembly 102 may vary to accommodate specific requirements of different applications. Additionally, the arrangement and number of the plurality of electrical terminals 315 within the first component 102A could be adjusted based on an application of the electrical connector assembly 102. For instance, the number of the plurality of electrical terminals 315 is determined based on a number of electrical wire configurations in the electrical connector assembly 102.

FIGS. 3E-3H illustrates engagement operation of the first component 102A and the second component 102B in various orientations, in accordance with example embodiments described herein. FIG. 3E illustrates a cross-sectional view of an engagement operation of the first component 102A with the second component 102B in a first orientation, in accordance with an exemplary embodiment of the present disclosure. As shown, the first component 102A is guided towards the second component 102B in an axial direction (depicted as z axis). The term “axial direction” (depicted as dashed lines) as used herein refers to a direction along the axis of an object, typically indicating movement or alignment along the lengthwise or central axis. The axial direction denotes the direction in which the first component 102A moves towards the second component 102B during assembly. The movement in the axial direction typically occurs along a straight line parallel to a central axis of the first component 102A and the second component 102B. As shown, the first component 102A is displaced towards the second component 102B in the axial direction.

Referring to FIG. 3F illustrated is a cross-sectional view of an engagement operation of the electrical connector assembly 102 in a second orientation, in accordance with an exemplary embodiment of the present disclosure. It may be appreciated that in an example, the second orientation can correspond to a state of engagement achieved after the first orientation (as shown in FIG. 3G), as the first component 102A is moved towards the second component 102B and vice versa, along the axis Z (e.g. for engaging the two components together). As shown, the second orientation represents the electrical connector assembly 102 in a centered position. As shown, the first retaining element 310 and the second retaining element 314 are configured to guide the first component 102A symmetrically along the axial direction towards the second component 102B. Said differently, the design of the first retaining element 310 and the second retaining element 314 ensures symmetrical alignment between the components so that that the first component 102A moves toward the center of the second component 102B, without tilting or skewing off from a central axis.

Moreover, as the first component 102A approaches the second component 102B, the first retaining element 310 and the second retaining element 314 engage with complementary features defined on the second component 102B, viz. the third cavity 336, the fourth cavity 338, the third retaining element 326 and the fourth retaining element 328. In other words, when in the centered position the first retaining element 310 and the second retaining element 314 are configured to retain the third retaining element 326 in the first cavity 308 and the fourth retaining element 328 in the second cavity 312. The first retaining element 310 and the second retaining element 314 are designed to exert sufficient retaining force on the third retaining element 326 and the fourth retaining element 328 when the first component 102A and the second component 102B are aligned in the centered position. It will be appreciated that the first retaining element 310 and the second retaining element 314 are configured to exert equal force (namely, retention force) on both the first side wall 304 and the second side wall 306 of the first component 102A. The equal forces prevent any lateral displacement or misalignment during the assembly process, thus ensuring that the first component 102A settles precisely at the center of the second component 102B. Moreover, achieving the centered position provides optimal electrical contact between the plurality of electrical terminals 315A-G (as depicted in FIG. 3C) of the first component 102A and the corresponding terminals or contacts of the second component 102B. Additionally, the centered position enhances the mechanical stability of the electrical connector assembly 102. Further, it may be appreciated that the precise shaping and positioning of a given retaining element relative to a given cavity, allows the first component 102A and the second component 102B to interlock effectively when the assembly is accurately aligned.

Referring to FIG. 3G illustrated is a cross-sectional view of the electrical connector assembly 102 in a third orientation, in accordance with an exemplary embodiment of the present disclosure. As shown, the third orientation could be a decentered position. It may be appreciated that in an example, the third orientation or decentered orientation can correspond to a state when an improper/misaligned engagement of the components is attempted. In an embodiment, when in the decentered position, the first retaining element 310 is configured to retain the third retaining element 326 on the first cavity 308 and the second retaining element 314 is configured to be inserted partially in the fourth cavity 338. The term “decentered position” as used herein refers to a state wherein the first component 102A and the second component 102B are not perfectly aligned or centered with respect to each other. In other words, the decentered position means that the first component 102A and the second component 102B are shifted or misaligned from their intended position of optimal alignment.

It may be appreciated that the decentered positions can occur due to various factors, including mechanical stress, vibrations, shocks, or improper installation. In an example concerning the vehicle, the electrical connector assembly 102 is used in the engine compartment of the vehicle. The electrical connector assembly 102 facilitates the connection of various engine components, such as sensors, actuators, and control modules. In such a case, where the vehicle encounters rough terrain or experiences sudden jolts, such as when driving over potholes or uneven surfaces. The vibrations and shocks generated during such conditions can cause the electrical connector assembly 102 to shift from its original centered position. Additionally, during maintenance or repair activities, if the electrical connector assembly 102 is not installed properly, the electrical connector assembly 102 might also end up in the decentered position. In this regard, the misalignment caused due to the decentered position can lead to issues such as poor electrical contact, intermittent connectivity, or even complete disconnection between the various components of the vehicle. As a result, critical functions controlled by the electrical components, such as engine performance or safety systems, may be adversely affected, leading to potential vehicle malfunctions or safety hazards.

It will be appreciated that in the depicted cross-sectional view, the first retaining element 310 retains the third retaining element 326 within the first cavity 308, thereby maintaining the connection therebetween despite the misalignment. Meanwhile, the second retaining element 314 is shown as partially inserted into the fourth cavity 338, indicating its continued engagement with the second component 102B even in the decentered position. The technical effect of employing the first retaining element 310 and the second retaining element 314 is to reduce the risk of electrical discontinuity or mechanical failure in automotive or industrial applications.

In an embodiment, the third orientation may be a rotated orientation in which the first component 102A and the second component 102B are not shifted along a straight line but are instead rotated around an axis. In an embodiment, the third orientation may be an angular misalignment that occurs when the first component 102A and the second component 102B are not aligned at the correct angle relative to each other. In an embodiment, the third orientation may be a tilted position that involves the first component 102A and the second component 102B being inclined or tilted relative to their intended alignment.

Referring to FIG. 3H illustrated is a cross-sectional view of the electrical connector assembly 102 in a fourth orientation, in accordance with another exemplary embodiment of the present disclosure. In an embodiment, the fourth orientation is a decentered position. In an embodiment, when in the decentered position, the second retaining element 314 is configured to retain the fourth retaining element 328 on the second cavity 312 and the first retaining element 310 is configured to be inserted partially in the third cavity 336. As shown, in the decentered position, the second retaining element 314 effectively holds the fourth retaining element 328 within the second cavity 312 to prevent a complete disengagement of the first component 102A from the second component 102B of the one or more electrical connector assembly 102. Meanwhile, the first retaining element 310 is partially inserted into the third cavity 336 to provide stabilization and additional support to the one or more electrical connector assembly 102. It will be appreciated that said arrangement reduce excessive movement between the first component 102A and the second component 102B, mitigating the risk of signal loss or mechanical damage.

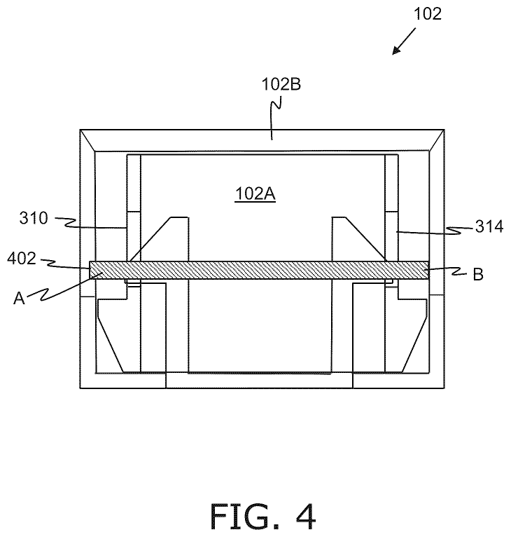

Referring to FIG. 4 illustrated is a cross sectional view of a third component 402 of an electrical connector assembly 102, in accordance with an exemplary embodiment of the present disclosure. As shown, the electrical connector assembly 102 (as depicted in FIG. 3A) further comprises the third component 402. The term “third component” as used herein refers to a mechanical component that comprises an elongated body with distinct ends such as a first end A and a second end B along with a body therebetween. In an embodiment, the third component 402 is selected from at least one of: a plate, a beam, a rod. Herein, the term “plate” refers to a flat, thin, and usually rectangular-shaped piece of material, typically characterized by its broad surface area compared to its thickness. The plate-shaped third component could be inserted into the electrical connector assembly 102 in such a way that its flat surface spans the distance between the first cavity 308 and the second cavity 312. It will be appreciated that the electrical connector assembly 102 gains enhanced structural integrity and resistance to deformation or misalignment by incorporating the plate as the third component 402.

Herein, the term “beam” refers to a long, straight structural element capable of withstanding loads primarily through bending. In an embodiment, the beam-shaped third component 402 could be positioned within the electrical connector assembly 102 to distribute forces evenly and provide additional structural support where needed. This results in a more robust and reliable electrical connector assembly 102, capable of withstanding dynamic operational conditions without compromising performance. Herein, the term “rod” refers to a long, slender cylindrical object with a relatively small diameter compared to its length. In an embodiment, the rod-shaped third component 402 may be inserted into the electrical connector assembly 102 to provide additional support and rigidity, particularly in scenarios where misalignment or disconnection may occur. Moreover, the third component 402 is designed to be operatively coupled to both the first component 102A and the second component 102B of the electrical connector assembly 102. In this regard, when inserted into the electrical connector assembly 102, the first end A of the third component 402 is positioned within the first cavity 308 of the first component 102A, while the second end is inserted within the second cavity 312 of the second component 102B.

In an embodiment, when the first component 102A is in a decentered position, the third component 402 is configured to pass through the first cavity 308 and the second cavity 312 to implement a secondary locking between the first component and the second component 102B. In this regard, when the first component 102A becomes misaligned or displaced from its intended position within the second component 102B, the third component 402 is configured to pass through the first cavity 308 and the second cavity 312. The third component 402 implements a secondary locking mechanism between the first component 102A and the second component 102B. It will be appreciated that the secondary locking mechanism is used to mitigate the negative effects of misalignment and ensure stable and secure connections between the first component 102A and the second component 102B. In an embodiment, the secondary locking mechanisms prevent disconnection, electrical interruptions, and mechanical failures in the electrical connector assembly 102. Advantageously, the third component 402 enables the electrical connector assembly 102 to minimize the risk of operational disruptions or safety hazards in the vehicle.

In a first aspect, the present disclosure provides an electrical connector assembly 102. The electrical connector assembly 102 includes a first component 102A and a second component 102B, operatively coupled to the first component 102A. The first component 102A includes a first side wall 304 and a second side wall 306 opposite to the first side wall 304. The first side wall 304 includes a first cavity 308 and a first retaining element 310 positioned adjacent to the first cavity 308. The second side wall 306 comprises a second cavity 312 and a second retaining element 314 that is positioned adjacent to the second cavity 312. The second component 102B is configured to receive the first component 102A. The second component 102B includes a first portion 318 and a second portion 320. The first portion 318 includes a third side wall 322 and a fourth side wall 324 opposite to the third side wall 322. The third side wall 322 includes a third retaining element 326 and the fourth side wall 324 includes a fourth retaining element 328. The second portion 320 includes a fifth side wall 330 and a sixth side wall 334 opposite to the fifth side wall 330. The fifth side wall 330 comprises a third cavity 336 and the sixth side wall 334 includes a fourth cavity 338. The first retaining element 310 and the second retaining element 314 are configured to guide the first component 102A in an axial direction towards the second component 102B at a centered position.

In an embodiment, when in the centered position the first retaining element 310 and the second retaining element 314 are configured to retain the third retaining element 326 in the first cavity 308 and the fourth retaining element 328 in the second cavity 312.

In an embodiment, when in a decentered position, the first retaining element 310 is configured to retain the third retaining element 326 on the first cavity 308 and the second retaining element 314 is configured to be inserted partially in the fourth cavity 338.

In an embodiment, when in the decentered position, the second retaining element 314 is configured to retain the fourth retaining element 328 on the second cavity 312 and the first retaining element 310 is configured to be inserted partially in the third cavity 336.

In an embodiment, the first retaining element 310 or the second retaining element 314 are configured to exert a pre-defined retention force between the first component 102A and the second component 102B.

In an embodiment, the first retaining element 310 or the second retaining element 314 is configured to exert the pre-defined retention force, and wherein the pre-defined retention force is defined based on at least one of: a size of the first retaining element 310 or the second retaining element 314, a tolerance of the first retaining element 310 or the second retaining element 314.

In an embodiment, the first component 102A and the second component 102B are fabricated from a plastic. In an embodiment, the first component 102A and the second component 102B are fabricated from a glass fiber. In an embodiment, the first component 102A and the second component 102B are fabricated from a combination of the plastic and the glass fiber.

In an embodiment, each of the first retaining element 310 and the third retaining element 326 includes a proximal end A, A′ and a distal end B, B′. In an embodiment, the proximal end of the third retaining element 326 is configured to lockingly engage with the distal end of the first retaining element 310.

In an embodiment, each of the second retaining element 314 and the fourth retaining element 328 includes a proximal end C, C′ and a distal end D, D′. In an embodiment, the proximal end C′ of the fourth retaining element 328 is configured to lockingly engage with the distal end D of the second retaining element 314.

In an embodiment, the electrical connector assembly 102 further includes a third component 402 operatively coupled to the first component 102A and the second component 102B. The third component 402 includes a first end, a second end and an elongated body between the first end and the second end, The third component 402 is configured to pass through the first cavity 308 and the second cavity 312 such that the first end is inserted into the first cavity 308 and the second end is inserted into the second cavity 312.

In an embodiment, when the first component 102A is in a decentered position, the third component 402 is configured to pass through the first cavity 308 and the second cavity 312 to implement a secondary locking between the first component 102A and the second component 102B.

In an embodiment, the third component 402 is a plate. In an embodiment, the third component 402 is a beam. In an embodiment, the third component 402 is a rod.

In an embodiment, the first component 102A further comprises a plurality of electrical terminals 315A-G, with each electrical terminal 315A-G being respectively terminated to ends of each of a plurality of electrical wires. The plurality of electrical terminals 315A-G is configured to provide electrical connections between the plurality of electrical wires and at least one external component 110, 112.

In a second aspect, the present disclosure provides an electrical connector assembly 102. The electrical connector assembly 102 includes a first component 102A and a second component 102B operatively coupled to the first component 102A. The first component 102A includes a first cavity 308 and a second cavity 312 disposed on opposite side walls of the first component. Moreover, the first component 102A includes a first retaining element 310 positioned adjacent to the first cavity 308 and a second retaining element 314 positioned adjacent to the second cavity 312. The second component 102B is configured to receive the first component 102A. The second component 102B includes a first portion 318 and a second portion 320. The first portion 318 includes a third retaining element 326 and a fourth retaining element 328 on opposite side walls of the first portion 318. The second portion 320 includes a third cavity 336 and a fourth cavity 338 on opposite side walls of the second portion 320. The first retaining element 310 and the second retaining element 314 are configured to guide the first component 102A in an axial direction towards the second component 102B at a centered position.

In a third aspect, the present disclosure provides a connector assembly 100 that includes one or more electrical connector assembly 102, 104 and a feed-through connector assembly 106, operatively coupled to the one or more electrical connector assembly 102, 104. Each of the one or more electrical connector assembly 102, 104 includes a first component 102A and a second component 102B, operatively coupled to the first component 102A. The first component 102A includes a first retaining element 310 positioned adjacent to a first cavity 308 and a second retaining element 314 positioned adjacent to a second cavity 312. The second component 102B is configured to receive the first component 102A. The second component 102B includes a first portion 318 and a second portion 320. The first portion 318 includes a third retaining element 326 and a fourth retaining element 328. The second portion 320 includes a third cavity 336 and a fourth cavity 338. The first retaining element 310 and the second retaining element 314 are configured to guide the first component 102A in an axial direction towards the second component 102B at a centered position. Moreover, the feed-through connector assembly 106 is operatively coupled to the one or more electrical connector assembly 102, 104 via at least one attachment means. The feed-through connector assembly 106 is configured to provide electrical connections between the one or more electrical connector assembly 102, 104 and one or more external components 110, 112 of a vehicle.

FIGS. 1 to 4 are merely examples, which should not unduly limit the scope of the claims herein. A person skilled in the art will recognize many variations, alternatives, and modifications of embodiments of the present disclosure.

1. An electrical connector assembly, comprising:
a first component, wherein the first component comprises:
a first side wall, wherein the first side wall comprises a first cavity and a first retaining element positioned adjacent to the first cavity, and
a second side wall opposite to the first side wall, wherein the second side wall comprises a second cavity and a second retaining element positioned adjacent to the second cavity; and
a second component, operatively coupled to the first component, and configured to receive the first component, wherein the second component comprises:
a first portion, wherein the first portion comprises:
a third side wall, and
a fourth side wall opposite to the third side wall,
wherein the third side wall comprises a third retaining element and the fourth side wall comprises a fourth retaining element, and
a second portion, wherein the second portion comprises
a fifth side wall, and
a sixth side wall opposite to the fifth side wall,
wherein the fifth side wall comprises a third cavity and the sixth side wall comprises a fourth cavity, and
wherein the first retaining element and the second retaining element are configured to guide the first component in an axial direction towards the second component at a centered position.

2. The electrical connector assembly of claim 1, wherein when in the centered position the first retaining element and the second retaining element are configured to retain the third retaining element in the first cavity and the fourth retaining element in the second cavity.

3. The electrical connector assembly of claim 1, wherein when in a decentered position, the first retaining element is configured to retain the third retaining element on the first cavity and the second retaining element is configured to be inserted partially in the fourth cavity.

4. The electrical connector assembly of claim 3, wherein when in the decentered position, the second retaining element is configured to retain the fourth retaining element on the second cavity and the first retaining element is configured to be inserted partially in the third cavity.

5. The electrical connector assembly of claim 1, wherein the first retaining element or the second retaining element are configured to exert a pre-defined retention force between the first component and the second component.

6. The electrical connector assembly of claim 5, wherein the first retaining element or the second retaining element is configured to exert the pre-defined retention force, and wherein the pre-defined retention force is defined based on at least one of: a size of the first retaining element or the second retaining element, a tolerance of the first retaining element or the second retaining element.

7. The electrical connector assembly of claim 1, wherein the first component and the second component are fabricated from at least one of: a plastic, a glass fiber, or a combination thereof.

8. The electrical connector assembly of claim 1, wherein each of the first retaining element and the third retaining element comprises a proximal end and a distal end, and
wherein the proximal end of the third retaining element is configured to lockingly engage with the distal end of the first retaining element.

9. The electrical connector assembly of claim 1, wherein each of the second retaining element and the fourth retaining element comprises a proximal end and a distal end, and wherein the proximal end of the fourth retaining element is configured to lockingly engage with the distal end of the second retaining element.

10. The electrical connector assembly of claim 1, further comprising a third component operatively coupled to the first component and the second component, wherein the third component comprises a first end, a second end and an elongated body between the first end and the second end, and the third component is configured to pass through the first cavity and the second cavity such that the first end is inserted into the first cavity and the second end is inserted into the second cavity.

11. The electrical connector assembly of claim 10, wherein when the first component is in a decentered position, the third component is configured to pass through the first cavity and the second cavity to implement a secondary locking between the first component and the second component.

12. The electrical connector assembly of claim 11, wherein the third component is selected from at least one of: a plate, a beam, a rod.

13. The electrical connector assembly of claim 1, wherein the first component further comprises a plurality of electrical terminals, with each electrical terminal being respectively terminated to ends of each of a plurality of electrical wires, and wherein the plurality of electrical terminals is configured to provide electrical connections between the plurality of electrical wires and at least one external component.

14. An electrical connector assembly, comprising:
a first component, wherein the first component comprises:
a first cavity and a second cavity disposed on opposite side walls of the first component, and
a first retaining element positioned adjacent to the first cavity and a second retaining element positioned adjacent to the second cavity; and
a second component, operatively coupled to the first component, and configured to receive the first component, wherein the second component comprises:
a first portion, wherein the first portion comprises a third retaining element and a fourth retaining element on opposite side walls of the first portion, and
a second portion having a third cavity and a fourth cavity on opposite side walls of the second portion,
wherein, the first retaining element and the second retaining element are configured to guide the first component in an axial direction towards the second component at a centered position.

15. A connector assembly comprising,
one or more electrical connector assemblies, wherein each of the one or more electrical connector assemblies comprising
a first component, and wherein the first component comprises a first retaining element positioned adjacent to a first cavity and a second retaining element positioned adjacent to a second cavity, and
a second component, operatively coupled to the first component, and configured to receive the first component, wherein the second component comprises
a first portion, wherein the first portion comprises a third retaining element and a fourth retaining element, and
a second portion, wherein the second portion comprises a third cavity and a fourth cavity, and wherein the first retaining element and the second retaining element are configured to guide the first component in an axial direction towards the second component at a centered position; and
a feed-through connector assembly, operatively coupled to the one or more electrical connector assemblies via at least one attachment means and configured to provide electrical connections between the one or more electrical connector assemblies and one or more external components of a vehicle.
